(19) United States
(12) Patent Application Publication
(10) Pub. No.: US 2005/0073501 A1
(43) Pub. Date: Apr. 7, 2005

(54) Advanced mouse

(76) Inventor: Richard Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/914,464

(22) Filed: Aug. 10, 2004

(30) Foreign Application Priority Data
Oct. 3, 2003 (TW) 92217808

(51) Int. Cl. G09G 5/08; G09G 5/00

(52) U.S. Cl. 345/163

(57) ABSTRACT

An advanced mouse has a standard mouse and a multi-function key. The multi-function key is used to activate a predetermined function or launch an application program via issuing a virtual combinative code. Thereby, the predetermined function or the application program can be activated without memorizing any combination keys, a universal serial bus (USB) hub, or a complex application or special driver. A Plug & Play function can thus be truly obtained.

### BACKGROUND OF THE INVENTION

1. Field of the Invention

The present invention is directed to an advanced mouse, and more particularly, to a mouse having multi-function keys that can easily perform a predetermined function or invoke application software. By using the present invention, a user doesn't need to memorize combinations of keys, connect the mouse to a universal serial bus (USB) hub or use a complex application or special driver. Hence, the advanced mouse of the present invention has a real plug & play function.

2. Description of Related Art

Due to unceasing development and research of information products, computer technology and software have enjoyed a considerable progression in function and speed. However, the methods for computer operation and document editing have not had any obvious improvement.

In general, the present method for computer operation or document editing needs to use a mouse to select a function item or limbs must be moved to typewrite. For a long-term computer worker( i.e. heavy user), this is strenuous, boring and inconvenient. Some typists suffer from occupational diseases of, for example, the hand, wrist or neck.

At present, Microsoft Company, whose products occupy a large share of the market, has issued several kinds of editing software, including Word, Excel, Power Point and so on. They can be used for, for example, business, editing a form and writing mail. When editing a document, a user not only needs to typewrite but also to move a mouse or use combinations of several keys to select function items to complete the editing of the document. However, since the user still needs to memorize the key combinations or use the mouse to activate the auxiliary functions to complete the edition of the document, the problem mentioned above is not greatly improved.

Although some so-called ergonomic keyboards have been introduced into the market in recent years, they still need the assistance of the mice when used. The moving number or distance of hands is not reduced at all. Hence, they are not very effective.

Therefore, in order to solve this problem, some specific function keys are added to the keyboards. For example, the traditional IBM keyboards, which had 83-84 keys originally, have been expanded to have 104-105 keys, including “Insert”, “Delete”, “Home”, “End”, “Page Up”, “Page Down”, “Up”, “Down”, “Left”, “Right” and so forth. For discrimination, the extended code “E0” is added in front of the original key codes, such as the key codes of the keys in Num Lock region. Thereby, function keys can be added.

Although adding function keys to the keyboard is a well-known technique, some inventors further add various specific hot keys to the conventional IBM standard keyboard to provide so-called multimedia keyboards via the IBM code-extending technique, as disclosed in, for example, Taiwan Patent No. 00332271 and 00378769. They use the WINexec 0 command of the keyboard driver or macro process to intercept the extended code of the keyboard or BIOS codes and store them into the system message queue so as to invoke the corresponding application program of the Windows operating system. During operation, when the user presses the hot key, the corresponding expanded function will be performed. Thereby, the inventors intend to further increase the efficiency of the keyboard.

Moreover, there are other hot-key techniques. For example, the WINMe, WIN2000, WINXP, WIN2003 Server have the standard interface functions used to invoke specific application programs or functions via using the path of the files or the file registries of the application programs. Thereby, the hot keys do not require the keyboard driver or macro process for operation, and hence the efficiency of the keyboard can be further increased.

However, from the aspect of operation or usage, the using hot-key techniques mentioned above still do not appreciably reduce mouse use. Hence, it isn't very helpful for the user, and has the following drawbacks.

A. Due to area restriction, it is not possible to add too many hot keys to the keyboard. The limitation is about twenty keys.

B. As disclosed in Taiwan Patent No. 00332271 and 00378769, using WINexc 0 to intercept the key code of the keyboard and invoke the application program of the Window operating system needs the support of the keyboard driver or macro process. Hence, the keyboard driver will occupy some of the computer resources and reduce the operation speed. Besides, installing the driver is usually bothersome for the user, and sometimes compatibility problems arises between the programs.

C. Although employing the standard interface functions of the Window operating system to invoke specific application programs or functions via using the path of the files or the file registries of the application programs doesn't need the support of the keyboard driver or macro process, the hot keys designed by using the standard interface functions can only activate some specific standard functions of the Window operating system, such as WWW, Email, Stop, My Favorites, Refresh, Search, Pre-page, Next-page, Volume up & down, Mute, Play/Pause, Pre-track, Next-track, Calculator, My computer, Power or Sleep. If it is necessary to add other additional functions, the driver should be modified correspondingly to provide these functions.

D. Using the techniques mentioned above can only activate some specific standard functions or application programs of the Window operating system. Hence, it isn't very helpful to users. Most users don't use the conventional hot keys of the keyboards and regard them more as decorations because the functions used frequently, such as Cut, Paste, Copy, Mark, Redo, Undo, Open, New, Bold, Save, Find, Reply, Send, Window Switch, and so forth, are not available completely.

Therefore, in order to solve the problems mentioned above, the inventor of the present invention proposed several inventions in 2001, such as Taiwan Patent No. 545644, 535945, China Patent ZL01219701.7, ZL02231501.2, ZL01227259.0, German Patent 20106926.1, 20113943.2, UK Patent GB2376440. A virtual combinative key code is issued by pressing a single module key (hot key) and support of the keyboard driver or macro process is not needed. Thereby, pressing a single hot key can directly control a specific internal function of the application programs, such as Cut, Paste, Copy, Mark, Redo, Undo, Open, New, Bold, Save, Find, Reply, Send, Window Switch, and so forth. Using a code transfer program can reach the same goal. By this way, the module keys (hot keys) are no longer decorations and the usage of the module keys will increase considerably. Thus, the frequency of using the mouse can be reduced and part of the problem mentioned above can be solved.

However, improving the functions of mice is still a good way to solve the problem. The present standard PS2/USB mouse as shown in FIGS. 1 and 2 can support three to five keys at most. If some of the keyboard hot keys are to be added to the mouse, a specific and complex driver is necessary because the I/O ports of the mouse and the keyboard need different control data. Otherwise, two cables together with two root ports, two PS2 ports or a USB hub, are necessary. The specific and complex driver will occupy a lot of computer resource and lower the operation speed of the computer. Installing the driver is also a troublesome job for the user. Besides, occupying too many root USB or PS2 ports is very uneconomic.

Therefore, in order to augment the root USB ports, some companies have developed USB hubs. The USB cables of the computer peripherals can be connected to the USB hub and the USB hub is capable of combining the data sent from the peripherals and sending the combined data to the root USB port.

Furthermore, some companies combine the USB hub with a keyboard, a mouse or a joystick so as to integrate the functions of the keyboard, mouse, joystick and so forth into a single hardware product. Thereby, the single hardware product can have various functions of the computer peripherals and use a single USB cable to connect with the root USB port so that it will not occupy too many root USB ports.

However, the circuits of the USB hub are complicated and can't be installed in a product with a small volume. Besides, installing the USB hub is also very costly. As a result, it is hard to commercialize this kind of product.

Accordingly, as discussed above, the prior art still has some drawbacks that could be improved. The present invention aims to resolve the drawbacks in the prior art.

### SUMMARY OF THE INVENTION

An objective of the present invention is to provide an advanced mouse. The present invention with capability to transfer hot keys from a keyboard, a remote controller, a joystick or other device in a mouse and further augments the hot keys. In this way, most of the function keys can be disposed on the mouse to activate a predetermined function or launch an application program. Hence, the number or frequency of hand movements between the keyboard and the mouse can be reduced. Therefore, the present invention is much more convenient and can reduce the injury rate for the user.

Another objective of the present invention is to provide an advanced mouse. The present invention transfer hot keys from a keyboard on the mouse and further augments the hot keys. Multi-function keys of the advanced mouse are connected to output lines of a single chip or ASIC inside the advanced mouse. The multi-function keys includes a combination of standard numerical keys, Application Switch key, a Wheel Bar Left key, a Wheel Bar Right key, a pre-page key, a next-page key, a Close key, a My Computer key, a My Document key, a cut key, a paste key, a copy key, a mark key, a redo key, an undo key, an open key, a new key, a bold key, a save key, a find key, a forward key, a send key, a WWW key, an E-mail key, a Stop key, a My Favorite key, a Refresh key, a Search key, a Volume up & down key, a Mute key, a Play/Pause key, a Calculator key, a Word key and an Excel key. A user can use these function keys to activate a predetermined function or launch an application program without memorizing key combinations or depending on a complex application or special driver.

Still another objective of the present invention is to provide an advanced mouse having a multi-function key. The present invention can dispose hot keys of a keyboard, a remote controller, a joystick or other device onto the mouse and further augment the hot keys. The user can use a finger to press a hot key disposed on the mouse to activate a specific function without moving his hand. Hence, the number or frequency of hand's movement between the keyboard and the mouse can be reduced so as to save strength, increase practical utility and prevent injury.

Even still another objective of the present invention is to provide an advanced mouse having a multi-function key. The present invention can dispose hot keys of a keyboard, a remote controller, a joystick or other device onto the mouse and further augment the hot keys. The user can use a finger to press a hot key disposed on the mouse to activate a specific function. The present invention only needs a single root USB port. It means that the present invention only needs to use a standard USB cable to connect with the single root USB port without a USB hub. Hence, the present invention can save the root USB ports of the computer system for other peripherals. If the prior art is directly applied to do the same, two independent products, such as a keyboard and a mouse, will require two cables, two root USB ports or two PS2 ports. Thus, using the prior art will use up all the root t USB ports or PS2 ports of the computer system speedily. That is very uneconomic.

A further objective of the present invention is to provide an advanced mouse having a multi-function key without using a complex application or special driver, except for a simple cod transfer program. The present invention will not occupy the computer resources, lower the operation speed, require troublesome software installation, or induce compatibility problems of the programs. In order to augment the function of the keys, the conventional standard mouse needs to use a complex driver to cooperate with the Windows system, such as Win98se, WinMe, WinNT, Win2000 or WinXp, or Mac system.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional mouse having three keys;

FIG. 2 is a schematic diagram of a conventional mouse having five keys;

FIG. 3 is a schematic diagram of an advanced mouse in accordance with the present invention;

FIG. 4 is a block diagram of an embodiment of the advanced mouse in accordance with the present invention;

FIG. 5 is a circuit diagram of an embodiment of the advanced mouse in accordance with the present invention;

FIG. 6 is a flowchart illustrating the operation of the single chip or ASIC in accordance with the present invention;

FIG. 7 is a table for providing the mapping between the physical multi-function keys and the virtual combinative codes;

FIG. 8 is a flowchart illustrating the operation of the present invention after the multi-function key is pressed;

FIG. 9 is another flowchart illustrating the operation of the present invention after the multi-function key is pressed; and

FIG. 10 is a circuit diagram of a wireless receiver in accordance with the present invention.

FIG. 11 is a circuit diagram of a wireless receiver in accordance with the present invention.

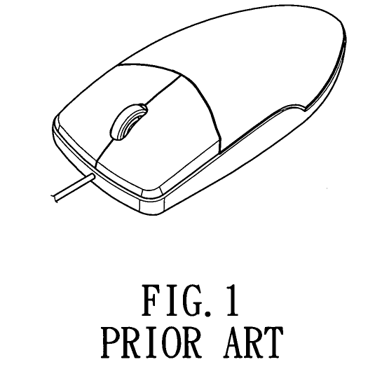

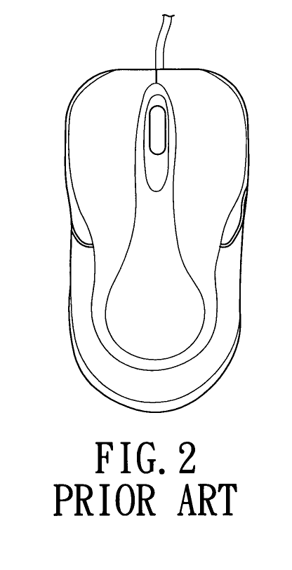

### DETAILED DESCRIPTION OF PREFERRED EMBODIMENTS

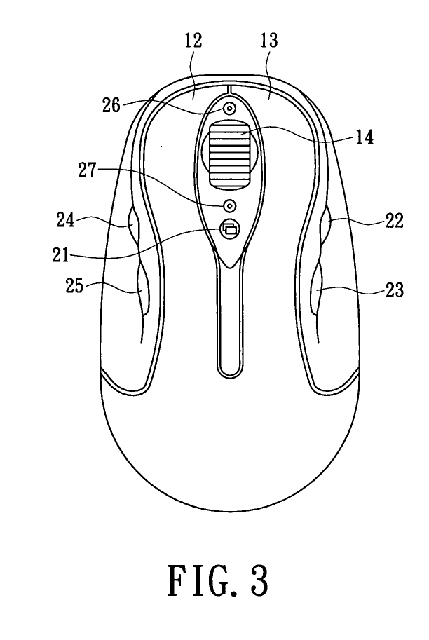

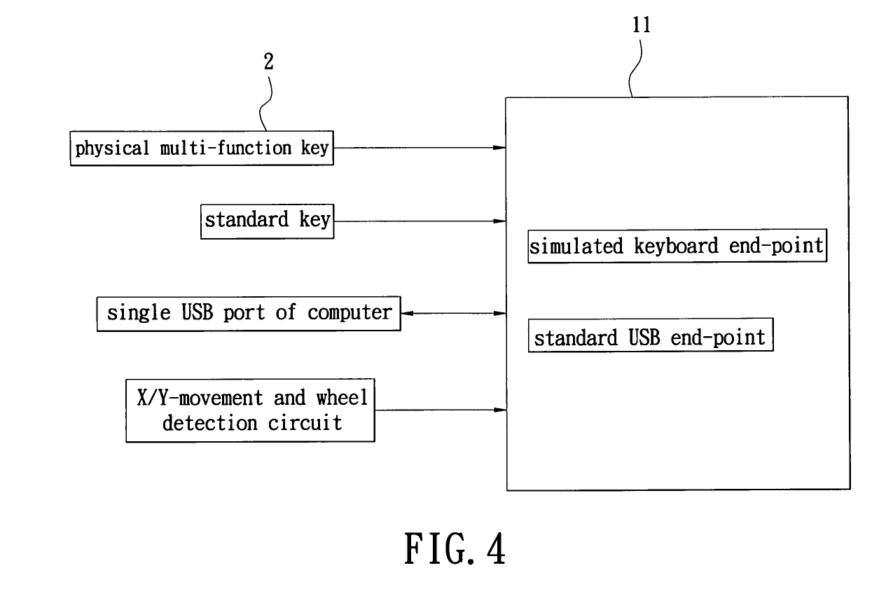

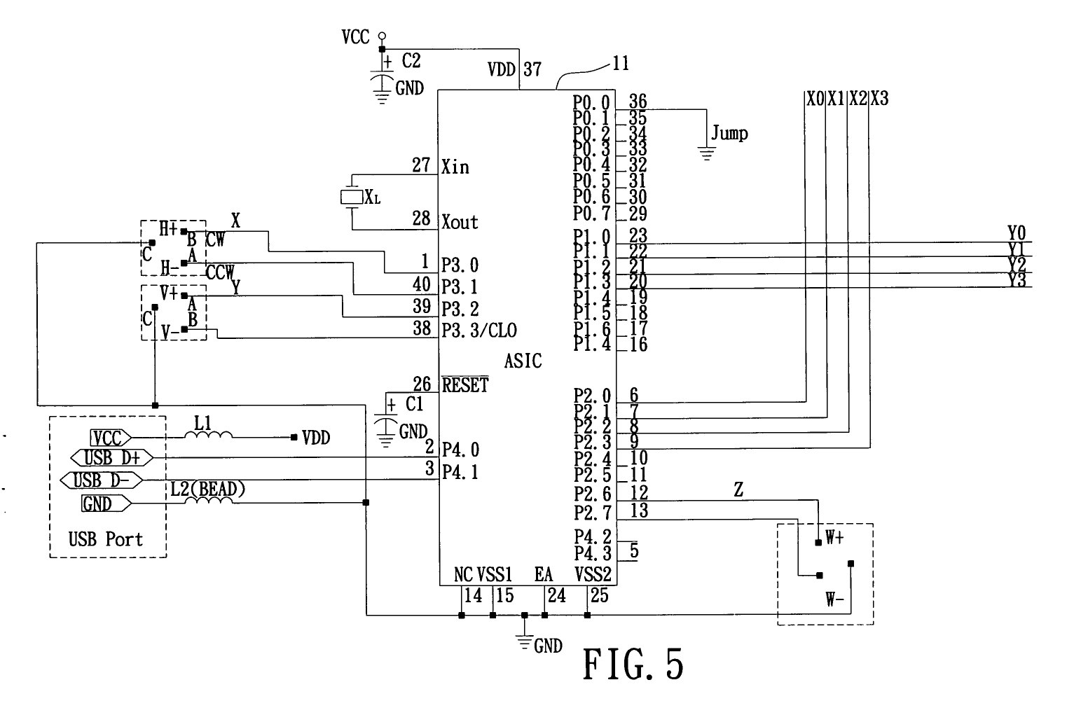

Reference is made to FIGS. 3-5. The present invention relates to an advanced mouse. It includes a mouse 1 and multi-function keys 2. Therein, the mouse 1 has a single chip or an application specific integrated circuit (ASIC) 11, which connects with a left key 12, a right key 13 and a wheel 14 of the upper cover of the mouse 1.

The multi-function keys 2 are disposed on finger-reachable portions of the upper cover of the mouse 1 and connected with the output lines of the single chip or the ASIC 11. In this embodiment, the multi-function keys include an application switch key 21, a wheel bar left key 22, a wheel bar right key 23, a pre-page key 24, a next-page key 25, a close key 26 and a my computer key 27.

Depending on the size of the mouse 1, the present invention can appropriately augment the multi-function keys 2, such as adding a set of standard keys (numerical keys), or adding keys for activating the functions of Application Switch, Cut, Paste, Copy, Mark, Redo, Undo, Open, New, Bold, Save, Find, Forward, Send, WWW, Email, Stop, My Favorites, Refresh, Search, Volume Up & Down, Mute, Play/Pause, Calculator, Word, Excel or combinations thereof.

The present invention uses the composite device function provided by the standard USB interface or dual end-point function provided by the wireless receiver. When the mouse 1 is plugged into the computer host, the single chip or ASIC 11 of the mouse 1 will inform the Windows system that two or more then two USB HID (human interface device) end-points have been connected thereon. One of the end-points is used for the standard wheel mouse having three or five keys. The other is used for the simulated keyboard or the keypad.

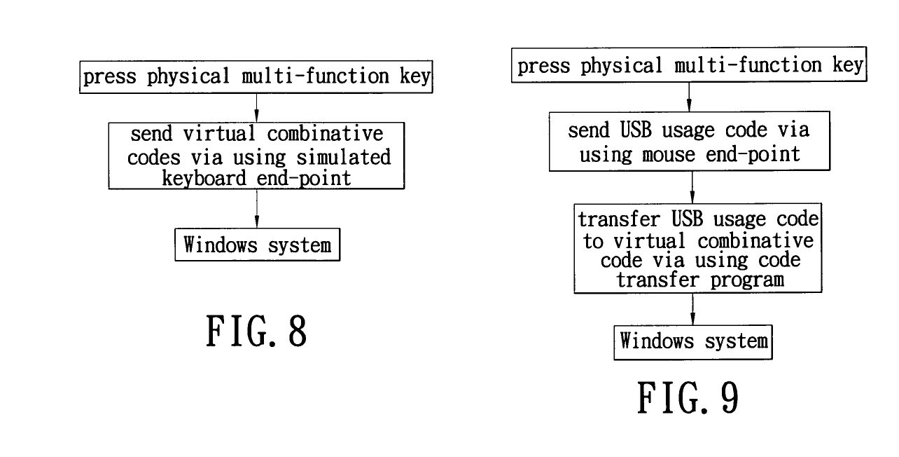

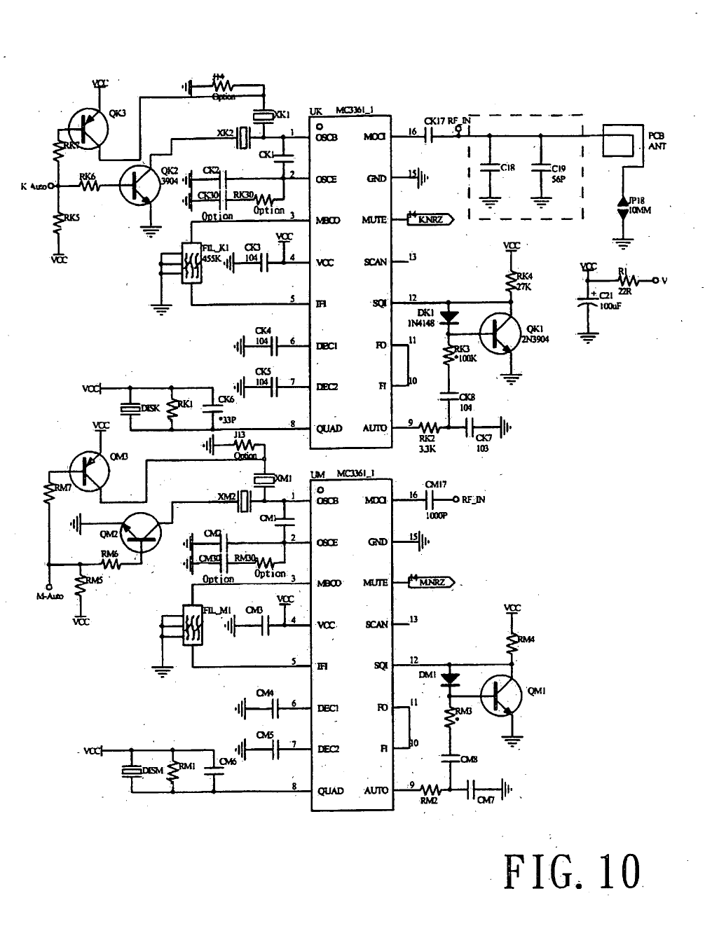

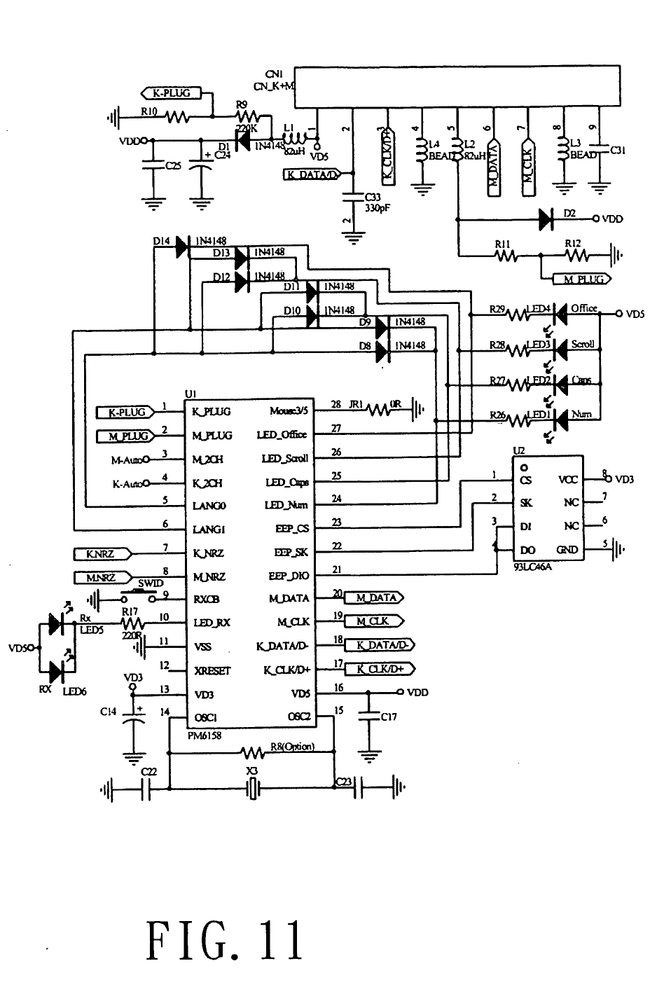

When the user presses one of the multi-function keys 2, the single chip or ASIC 11 will detect it automatically and send out a virtual USB combinative code to the Windows system via the simulated keyboard or key pad. Therein, the present invention can send out the virtual combinative code directly (as shown in FIG. 8), or send a specific extended code to a code transfer program and then transfer the extended code into the virtual combinative code (as shown in FIG. 9).

In order to transmit the virtual combinative code, a set of jumper wires, DIP switches, or diodes can be added into the circuits. Since the electrically erasable programmable read-only memory (EEPROM) is re-programmable, it is very suitable for a “wireless mouse+wired or wireless keyboard” product. If the mouse is a wireless product, in the selection of the components, such as EEPROM, of the receiver, which supports two end-points at least, the present invention can be implemented via PS2+USB ports, two PS2 ports or Mac ports (as shown in FIG. 10). Thus, the present invention can “keyboardize” the mouse or “mousize” the keyboard.

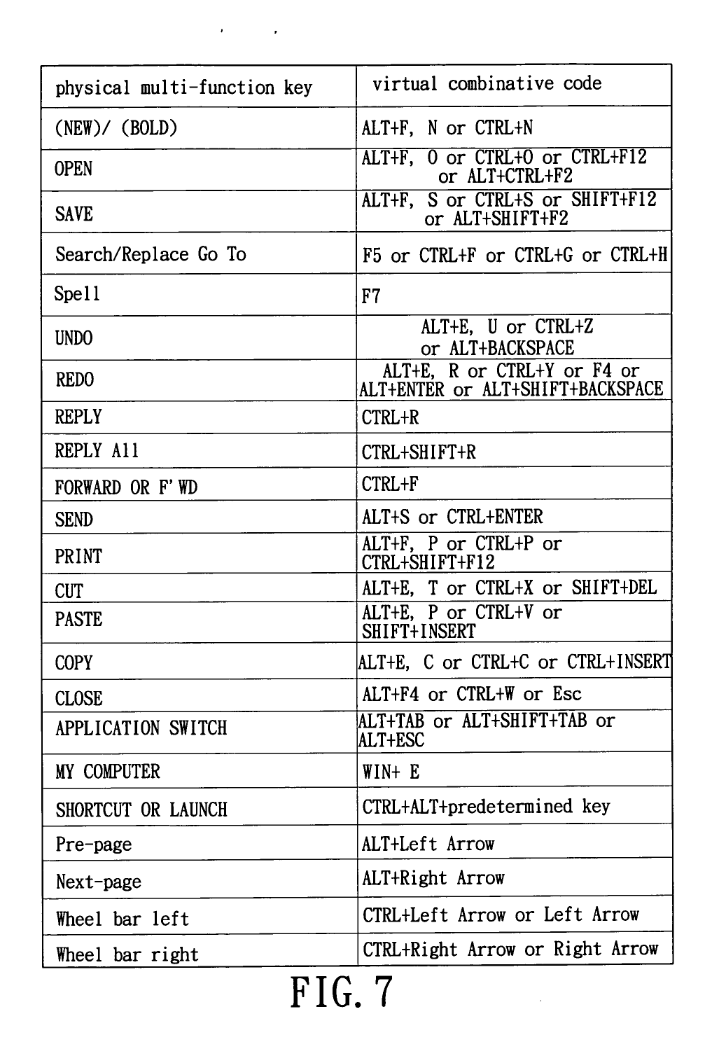

The table shown in FIG. 7 provides the mapping between the physical multi-function keys and the virtual combinative codes. In this way, the hot keys of the keyboard can be disposed on the mouse 1 and the multi-function keys can be augmented almost unlimitedly.

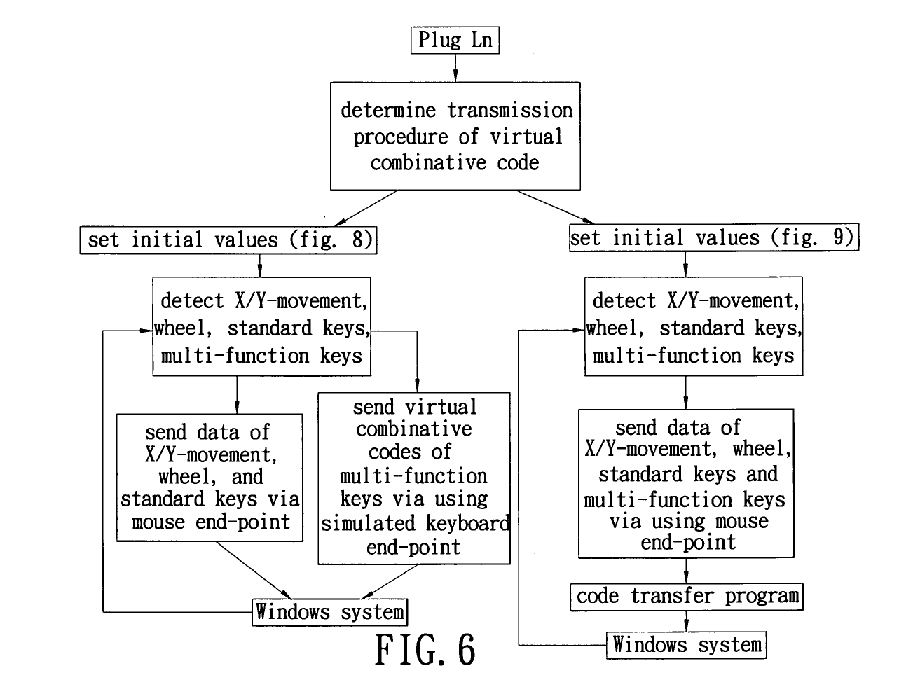

Reference is made to FIG. 6, which is a flowchart illustrating the operation of the single chip or ASIC in accordance with the present invention. When the advanced mouse is plugged in the computer system, it will be initialized. The single chip will perform a safety-testing process, determine the transmission procedure of the virtual combinative codes and initialize the end-points. Then, it will detect the X/Y-movement, the standard keys, the wheel and the multi-function keys. If the status of the mouse is changed, the corresponding data will be transmitted in accordance with the setting and used end-point.

Reference is made to FIG. 8, which is a flowchart illustrating the operation of the present invention after the multi-function key is pressed. Therein, after the multi-function key is pressed, the present invention can send out a virtual combinative code directly or a predetermined code, which can be transferred to a corresponding virtual combinative code via using the code transfer program.

Reference is made to FIG. 9, which is another flowchart illustrating the operation of the present invention after the multi-function key is pressed. Therein, after the multi-function key is pressed, the present invention will send a extended USB usage code or BIT mapping code to the code transfer program of the Windows system for the transferring the USB usage code to a corresponding virtual combinative code. This method can have the same effect as the operation shown in FIG. 8.

Summing up, the present invention has following features:
(1) A user can activate an application program via directly using the physical multi-function keys without memorizing key combinations, using a complex application or special driver, or using a keyboard driver (the present invention can use a code transfer program for code transferring). Hence, compatibility problems will not occur. If the mouse has an enough room, the multi-function keys can be added to the mouse unlimitedly. It can truly realize the Plug & Play function. The multi-function keys are compatible with the PC Windows system and part of the keys can be compatible with the MAC system.
(2) The mouse interface of the present invention only needs one root USB port. It can directly use a single standard USB cable to connect with the root USB of the computer system without using a USB Hub. Hence, the USB ports of the computer system can be saved for other peripherals.
(3) The present invention can lower costs and save resources. For example, the product of the present invention doesn't need an attached CD or floppy disk; requirements of root USB ports can be reduced; number of the used cables can be decreased; the USB hub is unnecessary; the resource of the computer occupied by the driver can be lowered; and the size of the product can be compact.
(4) For the wireless product, in the selection of the components, such as EEPROM, of the receiver, which supports two end-points at least, the present invention can be implemented via using PS2+USB ports, two PS2 ports or Mac ports (as shown in FIG. 10). For example, the receiver of the wireless product can receive a signal from a keyboard or mouse for function transferring and update the EEPROM accordingly. Then; when a user presses the multi-function key of the keyboard or mouse, the transferred function will be performed according to the setting of the EEPROM and the corresponding signals will be sent to the computer by a single wireless transmitter. Thus, the present invention can “keyboardize” the mouse or “mousize” the keyboard. Of course the wireless receiver can be disposed inside the wired keyboard.

Furthermore, the multi-function keys can be disposed on any portion of the mouse according to the practical requirements. The exterior of the mouse can also be modified. For example, the mouse can be disposed inversely and its track ball can be enlarged. The optical mouse can also be disposed inversely (reverse side) and a convex lens can be added on the optical sensor so that the mouse can be integrated into a keyboard or notebook computer and a user can use a finger to control the cursor. Moreover, a game pad (used to replace the track ball), a remote controller (i.e. specific wireless keyboard), or a decoration can also be added to the mouse.

As shown in FIG. 7, according to the practical requirements, the virtual combinative code of the multi-function key can be any combination of the key codes of SHIFT, CTRL, ALT, WIN or other keys of the standard keyboard. With the principle of press-release-press, the virtual combinative code can be issued via pressing a single key.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. An advanced mouse, comprising a standard mouse and a multi-function key disposed on the standard mouse, the multi-function key being used to transfer a target hot key from a keyboard, a remote controller or a predetermined input device and connected to output lines of a single chip or an application specific integrated circuit (ASIC), the multi-function key being used to activate a predetermined function or launch an application program via issuing a virtual combinative code, whereby the predetermined function or the application program is activated without memorizing any combination keys, a universal serial bus (USB) hub, or a complex application or special driver and hence a real Plug & Play function is provided.

2. The advanced mouse as claimed in claim 1, wherein the single chip or the ASIC have a capability to support standard USB interface and a composite device, and the standard USB interface is able to report two or more than two USB human interface device (HID) end-points, wherein the USB HID end-points includes a mouse, a simulated keyboard, a remote controller or a joystick.

3. The advanced mouse as claimed in claim 2, wherein the composite device reports two USB end-points and only requires a single root USB port of a computer via a standard USB cable.

4. The advanced mouse as claimed in claim 1, wherein the virtual combinative code is transmitted via using an USB HID simulated keyboard or key pad end-point, the virtual combinative code being used to simulate a keyboard or a key pad to send out the virtual combinative code.

5. The advanced mouse as claimed in claim 1, wherein the virtual combinative code is transmitted via using an USB HID mouse end-point, wherein the USB HID mouse end-point is used to send a standard USB extended usage code or a bit mapping code to a code transfer program so as to transfer the standard extended USB usage code or the bit mapping code to the virtual combinative code.

6. The advanced mouse as claimed in claim 1, wherein the virtual combinative code is transmitted via adding a jumper wire, switches diodes or a re-programmable device to a circuit, wherein the re-programmable device is suitable for a “wireless mouse+wired or wireless keyboard” product implemented via using a PS2 port and a USB port, two PS2 ports, or a Mac port.

7. The advanced mouse as claimed in claim 6, wherein the re-programmable device is an electrically erasable programmable read/write memory (EEPROM).

8. The advanced mouse as claimed in claim 1, wherein the multi-function keys includes a combination of standard numerical keys, Application Switch key, a Wheel Bar Left key, a Wheel Bar Right key, a pre-page key, a next-page key, a Close key, a My Computer key, a My Document key, a cut key, a paste key, a copy key, a mark key, a redo key, an undo key, an open key, a new key, a bold key, a save key, a find key, a forward key, a send key, a WWW key, an E-mail key, a Stop key, a My Favorite key, a Refresh key, a Search key, a Volume up & down key, a Mute key, a Play/Pause key, a Calculator key, a Word key and an Excel key; wherein the multi-function keys are simultaneously arranged and individually arranged.

9. The advanced mouse as claimed in claim 1, wherein the virtual combinative code of the multi-function key is a combination of key codes of a SHIFT key, a CTRL key, an ALT key, a WIN key and keys of the keyboard, wherein, via using a principle of press-release-press, the virtual combinative code is issued via using the multi-function key.

10. The advanced mouse as claimed in claim 1, wherein the advanced mouse is disposed inversely and has an enlarged track ball, an optical sensor having a convex lens is disposed thereon, a game pad is used to replace a standard track ball, a remote controller or a decoration, whereby the advanced mouse is integrated into a keyboard or a notebook computer and a user uses a finger to control a cursor by using the track ball or the optical sensor.
